(19) United States
(12) Patent Application Publication
(10) Pub. No.: US 2025/0093961 A1
(43) Pub. Date: Mar. 20, 2025

(54) SYSTEMS AND METHODS FOR INTERACTING WITH AN ELECTRONIC DISPLAY DEVICE

(71) Applicant: BARACODA DAILY HEALTHTECH, Neuilly-sur-Seine (FR)

(72) Inventors: Thomas SERVAL, Neuilly-sur-Seine (FR); Farid KILANI, Neuilly-sur-Seine (FR); Olivier GIROUD, Neuilly-sur-Seine (FR); Vincent EL KOUBY-BENICHOU, Neuilly-sur-Seine (FR)

(21) Appl. No.: 18/725,561

(22) PCT Filed: Dec. 29, 2022
(86) PCT No.: PCT/IB2022/000756

§ 371 Date: Jun. 28, 2024

Related U.S. Application Data
(60) Provisional application No. 63/295,300, filed on Dec. 30, 2021.

(51) Int. Cl. G06F 3/01; G06V 40/20

(52) U.S. Cl. CPC G06F 3/017; G06V 40/28

(57) ABSTRACT

A method of modifying execution of one or more applications being executed by one or more processors includes receiving image data reproducible as one or more images of (i) at least a portion of a hand of a user, (ii) at least a portion of an object held in the hand of the user, or (iii) both (i) and (ii); analyzing the image data, using the one or more processors, to determine (i) one or more gestures performed by the hand of the user, (ii) an identity of the object held in the hand of the user, or (iii) both (i) and (ii); and based at least in part on the one or more gestures, the identity of the object, or both, modifying the execution of the one or more applications being executed by the one or more processors.

### CROSS REFERENCE TO RELATED APPLICATION

This application claims priority to and benefit of U.S. Provisional Patent Application No. 63/295,300, filed Dec. 30, 2021, which is hereby incorporated by reference herein in its entirety.

### TECHNICAL FIELD

The present disclosure relates generally to systems and methods for interacting with an electronic display device, and more particularly, to systems and methods for recognizing gestures performed by an individual and modifying objects displayed on the electronic display device in response.

### SUMMARY

According to some implementations of the present disclosure, a method of modifying execution of one or more applications being executed by one or more processors includes receiving image data reproducible as one or more images of (i) at least a portion of a hand of a user, (ii) at least a portion of an object held in the hand of the user, or (iii) both (i) and (ii). The method further comprises analyzing the image data, using the one or more processors, to determine (i) one or more gestures performed by the hand of the user, (ii) an identity of the object held in the hand of the user, or (iii) both (i) and (ii). The method further comprises, based at least in part on the one or more gestures, the identity of the object, or both, modifying the execution of the one or more applications being executed by the one or more processors.

According to some implementations of the present disclosure, a system for modifying execution of one or more applications includes a control system and a memory. The control system includes one or more processors. The memory has stored thereon machine readable instructions. The control system is coupled to the memory, and when the machine executable instructions in the memory are executed by at least one of the one or more processors of the control system, a method is carried out. The method includes receiving image data reproducible as one or more images of (i) at least a portion of a hand of a user, (ii) at least a portion of an object held in the hand of the user, or (iii) both (i) and (ii). The method further comprises analyzing the image data, using the one or more processors, to determine (i) one or more gestures performed by the hand of the user, (ii) an identity of the object held in the hand of the user, or (iii) both (i) and (ii). The method further comprises, based at least in part on the one or more gestures, the identity of the object, or both, modifying the execution of the one or more applications being executed by the one or more processors

According to some implementations of the present disclosure, a system for modifying execution of one or more applications includes one or more image sensors, an electronic display device, a memory device storing machine-readable instructions; and a control system coupled to the memory device. The control system includes one or more processors configured to execute the machine-readable instructions to execute a method. The method includes generating image data reproducible as one or more images of (i) at least a portion of a hand of a user, (ii) at least a portion of an object held in the hand of the user, or (iii) both (i) and (ii). The method further includes analyzing the image data, using the one or more processors, to determine (i) one or more gestures performed by the hand of the user, (ii) an identity of the object held in the hand of the user, or (iii) both (i) and (ii). The method further includes, based at least in part on the one or more gestures, the identity of the object, or both, modifying the execution of the one or more applications being executed by the one or more processors.

According to some implementations of the present disclosure, a method of modifying execution of one or more applications being executed by one or more processors includes receiving image data reproducible as one or more images of at least a portion of a hand of a user. The method further includes analyzing the image data, using the one or more processors, to determine one or more gestures performed by the hand of the user. The method further includes, in response to determining that the hand of the user performed a first gesture, causing, using the one or more processors, a first modification of the execution of the one or more applications to occur. The method further includes, in response to determining that the hand of the user performed a second gesture, causing, using the one or more processors, a second modification of the execution of the one or more applications to occur, the second gesture being different than the first gesture, the second modification being different than the first modification.

According to some implementations of the present disclosure, a system for modifying execution of one or more applications includes a control system and a memory. The control system includes one or more processors. The memory has stored thereon machine readable instructions. The control system is coupled to the memory, and when the machine executable instructions in the memory are executed by at least one of the one or more processors of the control system, a method is carried out. The method includes receiving image data reproducible as one or more images of at least a portion of a hand of a user. The method further includes analyzing the image data, using the one or more processors, to determine one or more gestures performed by the hand of the user. The method further includes, in response to determining that the hand of the user performed a first gesture, causing, using the one or more processors, a first modification of the execution of the one or more applications to occur. The method further includes, in response to determining that the hand of the user performed a second gesture, causing, using the one or more processors, a second modification of the execution of the one or more applications to occur, the second gesture being different than the first gesture, the second modification being different than the first modification.

According to some implementations of the present disclosure, a system for modifying execution of one or more applications includes one or more image sensors, an electronic display device, a memory device storing machine-readable instructions; and a control system coupled to the memory device. The control system includes one or more processors configured to execute the machine-readable instructions to execute a method. The method includes generating image data reproducible as one or more images of at least a portion of a hand of a user. The method further includes analyzing the image data, using the one or more processors, to determine one or more gestures performed by the hand of the user. The method further includes, in response to determining that the hand of the user performed a first gesture, cause, using the one or more processors, a first modification of the execution of the one or more applications to occur. The method further includes, in response to determining that the hand of the user performed a second gesture, cause, using the one or more processors, a second modification of the execution of the one or more applications to occur, the second gesture being different than the first gesture, the second modification being different than the first modification.

The above summary is not intended to represent each implementation or every aspect of the present disclosure. Additional features and benefits of the present disclosure are apparent from the detailed description and figures set forth below.

### BRIEF DESCRIPTION OF THE DRAWINGS

The foregoing and other advantages of the present disclosure will become apparent upon reading the following detailed description and upon reference to the drawings.

FIG. 1 is a block diagram of a smart mirror system, according to some implementations of the present disclosure;

FIG. 2 is a perspective view of the smart mirror system of FIG. 1, according to some implementations of the present disclosure;

FIG. 3A is a front elevation view of the smart mirror system of FIG. 1, according to some implementations of the present disclosure;

FIG. 3B is a side elevation view of the smart mirror system of FIG. 1, according to some implementation of the present disclosure;

FIG. 4 is a flowchart of a method modifying execution of one or more applications, according to some implementations of the present disclosure;

FIG. 5A is front view of a user holding their hand in a first position and a first application being shown on a display device, according to some implementations of the present disclosure;

FIG. 5B is a front view of the user moving their hand to a second position to switch from the first application to a second application, according to some implementations of the present disclosure;

FIG. 6A is front view of a user holding their hand in a first position and a first menu option of an application being highlighted on a display device, according to some implementations of the present disclosure;

FIG. 6B is a front view of the user moving their hand to a second position to navigate to a second menu option of the application, according to some implementations of the present disclosure;

FIG. 7A is front view of a user holding their hand in a first position while a setting of an application that is shown on a display device has a first value, according to some implementations of the present disclosure;

FIG. 7B is a front view of the user moving their hand to a second position to change the value of the setting of the application from the first value to a second value, according to some implementations of the present disclosure;

FIG. 8A is front view of a user holding their hand in a first position and while an object is shown on a display device, according to some implementations of the present disclosure;

FIG. 8B is a front view of the user moving their hand to a second position to zoom in on the object shown in the display device, according to some implementations of the present disclosure;

FIG. 9A is a front view of a user holding an object in front a display device, according to some implementations of the present disclosure;

FIG. 9B is a front view of an application being launched and shown on the display device in response to determining the identity of the object held by the user, according to some implementations of the present disclosure;

FIG. 9C is a front view of the user moving the object adjacent to a first portion of the user's face, and a digital representation of the user shown on the display device with a first marker overlaid on a portion of the digital representation of the user that corresponds to the first portion of the user's face, according to some implementations of the present disclosure; and

FIG. 9D is a front view of the user moving the object adjacent to a second portion of the user's face, and a second marker overlaid on a portion on the digital representation of the user that corresponds to the second portion of the user's face, according to some implementations of the present disclosure, according to some implementations of the present disclosure.

While the present disclosure is susceptible to various modifications and alternative forms, specific implementations and embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION

Disclosed herein are systems and methods for allowing a user to interact with an electronic display device by performing various gestures. The gestures can include various different movements of the user's hand(s) and/or other body parts, the user's hand(s) and/or other body parts being in certain positions, and other gestures. The gestures may also include different movements and/or positions of an object that the user is holding in their hand. In response to detecting a gesture made by the user and/or identifying the object the user is holding, the execution of an application that is executed by one or more processing devices can be modified. The modification of the execution of the application can include launching the application, quitting the application, switching between different applications, adjusting one or more settings of the application, displaying items on an electronic display device, modifying displayed items on an electronic display device, and others.

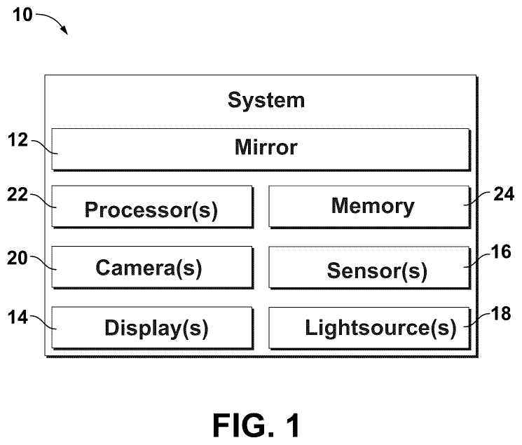

Referring now to FIG. 1, a smart mirror system 10 according to the present disclosure includes a mirror 12, one or more electronic displays 14, one or more sensors, one or more light sources 18, and one or more cameras 20. The system generally also includes at least one processor 22 with a memory 24. The memory 24 generally contains processor-executable instructions that when executed by the processor 22, run an operating system and/or an application on the display 14. The mirror 12 is of a type that is generally referred to as a one-way mirror, although it is also sometimes referred to as a two-way mirror. The mirror 12 is configured transmit a first portion of light that is incident on its surfaces to the other side of the mirror 12, and to reflect a second portion of the light that is incident on its surfaces. This may be accomplished by applying a thin layer of a partially reflective coating to a generally transparent substrate material, such that less than all of the incident light is reflected by the partially reflecting coating. The remaining light is transmitted through the mirror 12 to the other side. Similarly, some light that strikes the mirror 12 on a side opposite the side where a user is standing will be transmitted through the mirror 12, allowing the user to see that transmitted light. This partially reflective coating can generally be applied to surface of the substrate material on the display-side of the substrate material, the user-side of the substrate material, or both. Thus, the partially reflective coating can be present on the surface of one or both of the display-side and the user-side of the mirror 12. In some implementations, the partially reflective coating is made of silver. The generally transparent material can be glass, acrylic, or any other suitable material. The mirror 12 can have a rectangular shape, an oval shape, a circle shape, a square shape, a triangle shape, or any other suitable shape. The processor 22 is communicatively coupled with the electronic display 14, the one or more sensors 16, the one or more light sources 18, and the one or more cameras 20.

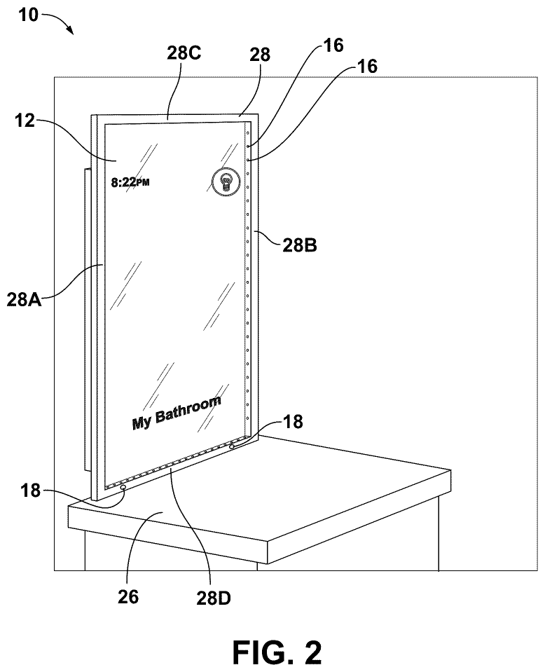

Referring now to FIG. 2, the mirror 12 can be mounted on a base 26. The mirror could also be directly mounted in a counter, a wall, or any other structure. The electronic display 14 is mounted on, coupled to, or otherwise disposed on a first side of the mirror 12, while a sensor frame 28 containing the one or more sensors 16 is disposed at an opposing second side of the mirror 12. The side of the mirror 12 where the display 14 is located is generally referred to as the display-side of the mirror 12. The side of the mirror 12 where the sensor frame 28 is located is generally referred to as the user-side of the mirror 12, as this is the side of the mirror 12 where the user will be located during operation.

The electronic display 14 is generally mounted in close proximity to the surface of the display-side of the mirror 12. The electronic display 14 can be any suitable device, such as an LCD screen, an LED screen, a plasma display, an OLED display, a CRT display, or the like. Due to the partially reflective nature of the mirror 12, when the display 14 is activated (e.g. turned on and emitting light to display an image), a user standing on the user-side of the mirror 12 is able to view any portion of the display 14 that is emitting light through the mirror 12. When the display 14 is turned off, light that is incident on the user-side of the mirror 12 from the surroundings will be partially reflected and partially transmitted. Because the display 14 is off, there is no light being transmitted through the mirror 12 to the user-side of the mirror 12 from the display-side. Thus, the user standing in front of the mirror 12 will see their reflection due to light that is incident on the user-side of the mirror 12 and is reflected off of the mirror 12 back at the user. When the display 14 is activated, a portion of the light produced by the display 14 that is incident on the mirror 12 from the display-side is transmitted through the mirror 12 to the user-side. The mirror 12 and the display 14 are generally configured such that the intensity of the light that is transmitted through the mirror 12 from the display 14 at any given point is greater than the intensity of any light that is reflected off of that point of the mirror 12 from the user-side. Thus, a user viewing the mirror 12 will be able to view the portions of the display 14 that are emitting light, but will not see their reflection in the portions of those mirror 12 through which the display light is being transmitted.

The electronic display 14 can also be used to illuminate the user or other objects that are located on the user-side of the mirror 12. The processor 22 can activate a segment of the display 14 that generally aligns with the location of the object relative to the mirror 12. In an implementation, this segment of the display 14 is activated responsive to one of the one or more sensors 16 detecting the object and its location on the user-side of the mirror 12. The segment of the display 14 can have a ring-shaped configuration which includes an activated segment of the display 14 surrounding a non-activated segment of the display 14. The non-activated segment of the display 14 could be configured such that no light is emitted, or could be configured such that some light is emitted by the display in the non-activated segment, but it is too weak or too low in intensity to be seen by the user through the mirror 12. In an implementation, the activated segment of the display 14 generally aligns with an outer periphery of the object, while the non-activated segment of the display 14 generally aligns with the object itself. Thus, when the object is a user's face, the user will be able to view the activated segment of the display 14 as a ring of light surrounding their face. The non-activated segment of the display 14 will align with the user's face, such that the user will be able to see the reflection of their face within the ring of light transmitted through the mirror. In another implementation, the non-activated segment of the display aligns with the object, and the entire remainder of the display 14 is the activated segment. In this implementation, the entire display 14 is activated except for the segment of the display 14 that aligns with the object.

Generally, the system 10 includes one or more sensors 16 disposed in the sensor frame 28. The sensor frame 28 is mounted on, couple to, or otherwise disposed at the second side (user-side) of the mirror 12. The sensors 16 are generally located within a range of less than about five inches from the user-side surface of the mirror 12. In other implementations, the sensors 16 could be disposed between further away from the surface of the mirror 12, such as about between about 5 inches and about 10 inches. The sensors 16 are configured to detect the presence of a hand, finger, face, or other body part of the user when the user is within a threshold distance from the mirror 12. This threshold distance is the distance that the sensors 16 are located away from the user-side surface of the mirror 12. The sensors 16 are communicatively coupled to the 2 or 22 and/or memory 24. When the sensors 16 detect the presence of the user aligned with a certain point of the mirror 12 (and thus the display 14), the processor 22 is configured to cause the display 14 to react as if the user had touched or clicked the display 14 at a location on the display 14 corresponding to the point of the mirror 12. Thus, the sensors 16 are able to transform the mirror/display combination into a touch-sensitive display, where the user can interact with and manipulate applications executing on the display 14 by touching the mirror 12, or even bringing their fingers, hands, face, or other body part in close proximity to the user-side surface of the mirror 12. In some implementations, the sensors 16 can include a microphone that records the user's voice. The data from the microphone can be sent to the processor 22 to allow the user to interact with the system using their voice.

The one or more sensors 16 are generally infrared sensors, although sensors utilizing electromagnetic radiation in other portions of the electromagnetic spectrum could also be utilized. The sensor frame 28 can have a rectangular shape, an oval shape, a circular shape, a square shape, a triangle shape, or any other suitable shape. In an implementation, the shape of the sensor frame 28 is selected to match the shape of the mirror 12. For example, both the mirror 12 and the sensor frame 28 can have rectangular shapes. In another implementation, the sensor frame 28 and the mirror 12 have different shapes. In an implementation, the sensor frame 28 is approximately the same size as the mirror 12 and generally is aligned with a periphery of the mirror 12. In another implementation, the sensor frame 28 is smaller than the mirror 12, and is generally aligned with an area of the mirror 12 located interior to the periphery of the mirror 12. In a further implementation, the sensor frame 28 could be larger than the mirror 12.

In an implementation, the mirror 12 generally has a first axis and a second axis. The one or more sensors 16 are configured to detect a first axial position of an object interacting with the sensors 16 relative to the first axis of the mirror 12, and a second axial position of the object interacting with the sensors relative to the second axis of the mirror 12. In an implementation, the first axis is a vertical axis and the second axis is a horizontal axis. Thus, in viewing the sensor frame 28 from the perspective of the user, the sensor frame 28 may have a first vertical portion 28A and an opposing second vertical portion 28B, and a first horizontal portion 28C and an opposing second horizontal portion 28D. The first vertical portion 28A has one or more infrared transmitters disposed therein, and the second vertical portion 28B has one or more corresponding infrared receivers disposed therein. Each individual transmitter emits a beam of infrared light that is received by its corresponding individual receiver. When the user places a finger in close proximity to the mirror 12, the user's finger can interrupt this beam of infrared light such that the receiver does not detect the beam of infrared light. This tells the processor 22 that the user has placed a finger somewhere in between that transmitter/receiver pair. In an implementation, a plurality of transmitters is disposed intermittently along the length of the first vertical portion 28A, while a corresponding plurality of receivers is disposed intermittently along the length of the second vertical portion 28B. Depending on which transmitter/receiver pairs detect the presence of the user's finger (or other body part), the processor 22 can determine the vertical position of the user's finger relative to the display 14. The first axis and second axis of the mirror 12 could be for a rectangular-shaped mirror, a square-shaped mirror, an oval-shaped mirror, a circle-shaped mirror, a triangular-shaped mirror, or any other shape of mirror.

The sensor frame 28 similarly has one or more infrared transmitters disposed intermittently along the length of the first horizontal portion 28C, and a corresponding number of infrared receivers disposed intermittently along the length of the second horizontal portion 28D. These transmitter/receiver pairs act in a similar fashion as to the ones disposed along the vertical portions 28A, 28B of the sensor frame 28, and are used to detect the presence of the user's finger and the horizontal location of the user's finger relative to the display 14. The one or more sensors 16 thus form a two-dimensional grid parallel with the user-side surface of the mirror 12 with which the user can interact, and where the system 10 can detect such interaction.

In other implementations, the sensor frame 28 may include one or more proximity sensors, which can be, for example, time of flight sensors. Time of flight sensors do not rely on separate transmitters and receivers, but instead measure how long it takes an emitted signal to reflect off on an object back to its source. A plurality of proximity sensors on one edge of the sensor frame 28 can thus be used to determine both the vertical and horizontal positions of an object, such as the user's hand, finger, face, etc. For example, a column of proximity sensors on either the left or right edge can determine the vertical position of the object by determining which proximity sensor was activated, and can determine the horizontal position by using that proximity sensor to measure how far away the object is from the proximity sensor. Similarly, a row of proximity sensors on either the top or bottom edge can determine the horizontal position of the object by determining which proximity sensor was activated, and can determine the vertical position by using that proximity sensor to measure how far away the object is from the proximity sensor.

The sensors in the sensor frame 28 (whether IR transmitter/receiver pairs or proximity sensors) can be used by the system to determine different types of interactions between the user and the system. For example, the system can determine whether the using is swiping horizontally (left/right), vertically (up/down), or diagonally (a combination of left/right and up/down). The system can also detect when the user simply taps somewhere instead of swiping. In some implementations, the sensor frame 28 is configured to detect interactions between the user and the system when the user is between about 3 centimeters and about 15 centimeters from the surface of the mirror.

The system 10 further includes one or more light sources 18. In an implementation, the light sources 18 are light emitting diodes (LEDs) having variable color and intensity values that can be controlled by the processor 22. In other implementations, the light sources 18 can be incandescent light bulbs, halogen light bulbs, fluorescent light bulbs, black lights, discharge lamps, or any other suitable light source. The light sources 18 can be coupled to or disposed within the base 26 of the system 10, or they can be coupled to or disposed within the sensor frame 28. For example, while FIG. 2 only shows two light sources 18 disposed in a bottom portion of the system 10, a plurality of light sources 18 could be disposed about the frame such that the light sources 18 generally surround the mirror. In some implementations, the light sources 18 may be disposed on either the user-side of the mirror 12 or the display-side of the mirror 12. When disposed on the user-side of the mirror 12, the light emitted by the light sources 18 is configured to travel through the mirror 12 towards the user. The light sources 18 can also be rotationally or translationally coupled to the sensor frame 28 or other parts of the system 10 such that the light sources 18 can be physically adjusted by the user and emit light in different directions. The light sources 18 could also be disposed in individual housings separate from the mirror/display combination. The light sources 18 are configured to produce light that is generally directed outward away from the mirror 12 and toward the user. The light produced by the one or more light sources 18 can thus be used to illuminate the user (or any other object disposed on the user-side of the mirror). Because they are variable in color and intensity, the light sources 18 can thus be used to adjust the ambient light conditions surrounding the user.

The system 10 also includes one or more cameras 20 mounted on or coupled to the mirror 12. The cameras 20 could be optical cameras operating using visible light, infrared (IR) cameras, three-dimensional (depth) cameras, or any other suitable type of camera. The one or more cameras 20 are disposed on the display-side of the mirror 12. In an implementation, the one or more cameras 20 are located above the electronic display 14, but are still behind the mirror 12 from the perspective of the user. The lenses of the one or more cameras 20 faces toward the mirror 12 and are thus configured to monitor the user-side of the mirror 12. In an implementation, the one or more cameras 20 monitor the user-side of the mirror 12 through the partially reflective coating on the mirror 12. In another implementation, the one or more cameras 20 are disposed at locations of the mirror 12 where no partially reflective coating exists, and thus the one or more cameras 20 monitor the user-side of the mirror 12 through the remaining transparent material of the mirror 12. The one or more cameras 20 may be stationary, or they may be configured to tilt side-to-side and up and down. The cameras 20 can also be moveably mounted on a track and be configured to move side-to-side and up and down. The one or more cameras 20 are configured to capture still images or video images of the user-side of the mirror 12. The display 14 can display real-time or stored still images or video images captured by the one or more cameras 20.

The one or more cameras 20 are communicatively coupled to the processor 22. The processor 22, using the still or video images captured by the one or more cameras 20, can detect and identify a variety of objects using computer vision. The processor 22 can be configured to modify the execution of an application being executing by the processor 22, such as automatically launching a new application or taking a certain action in an existing application, based on the object that is detected and identified by the cameras 20 and the processor 22. For example, following the detection of an object in the user's hand and the identification of that object as a makeup brush, the processor 22 can be configured to automatically launch a makeup-related application to run on the display 14, or launch a makeup feature in the current application. In another example, the processor 22 can be configured to automatically launch an application to assist the user in using any other type of object or implement, such as a razor (e.g., launching a shaving-related application), an eyebrow pencil, a hair brush, a comb, etc. The one or more cameras 20 can also recognize faces of users and differentiate between multiple users. For example, the camera 20 may recognize the person standing in front of the mirror 12 and execute an application that is specific to that user. For example, the application could display stored data for that user, or show real-time data that is relevant to the user.

In an implementation, the processor 22 can be configured to execute a first application while the display 14 displays a first type of information related to the first application. Responsive to the identification of the object by the system 10, the processor is configured to cause the display 14 to display a second type of information related to the first application, the second type of information being (i) different from the first type of information and (ii) based on the identified object. In another implementation, responsive to the identification of the object, the processor is configured to execute a second application different from the first application, the second application being based on the identified object.

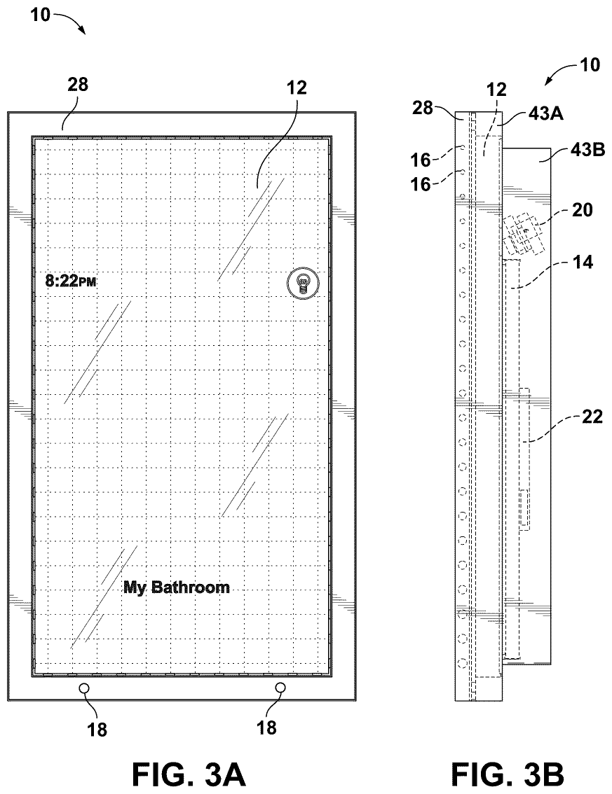

FIG. 3A illustrates a front elevation view of the system 10, while FIG. 3B illustrates a side elevation view of the system 10. As can be seen in FIG. 3A, the sensor frame 28 surrounds the mirror 12, while portions of the display 14 that are activated are visible through the mirror 12. FIG. 3A also shows the two-dimensional grid that can be formed by the sensors 16 in the sensor frame 28 that is used to detect the user's finger, head, or other body part. This two-dimensional grid is generally not visible to the user during operation. FIG. 3B shows the arrangement of the sensor frame 28 with the sensors 16, the mirror 12, the display 14, and the camera. In an implementation, the processor 22 and the memory 24 can be mounted behind the display 14. In other implementations, the processor 22 and the memory 24 may be located at other portions within the system 10, or can be located external to the system 10 entirely. The system 10 generally also includes housing components 43A, 43B that form a housing that contains and protects the display 14, the camera, and the processor 22.

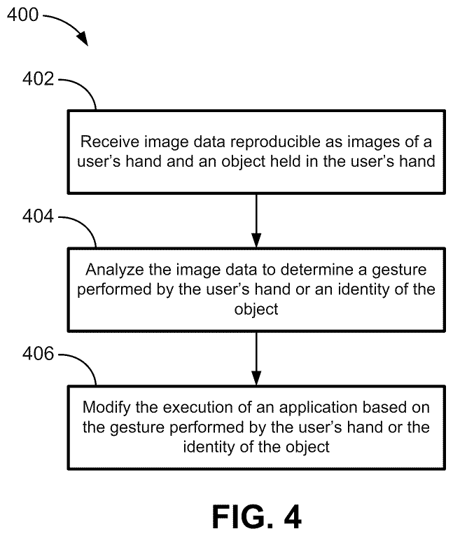

FIG. 4 shows a flowchart of a method 400 for executing one or more applications being executed by one or more processors. Method 400 can be implemented using any suitable components. For example, in some implementations, method 400 is implemented using the components of the smart mirror system 10, including the display 14, the one or more processors 22, the one or more memory devices 24, the one or more cameras 20, and/or other components.

The smart mirror 10 can be used to execute a number of different applications (or programs) related to the user's use of different objects that the user may hold in their hand. For example, the processors 22 of the smart mirror 10 can execute a shaving application to assist the user in shaving. In another example, the processors 22 of the smart mirror 10 can execute a makeup application to assist the user in applying makeup, for example using a makeup brush or an eyebrow pencil. During the execution of these applications, various items can be shown on the display 14 of the smart mirror 10. These items can include images, text, videos (including pre-recorded videos and real-time videos), app icons, plots, charts, graphs, etc. The applications may also include a number of different settings that can be adjusted, such as volume, brightness, etc. Method 400 is a method of modifying the execution of any of these applications based on gestures made by the user, the identity of any objects being held in the user's hands, or both.

Step 402 of method 400 includes receiving image data that is reproducible as one or more images of at least a portion of the user's hand, at least a portion of an object held in the user's hand, or both. The image data can be generated using any suitable type and number of image sensors. For example, in some implementations, the camera 20 mounted above the display 12 of the smart mirror 10 can be used to generate the image data when the user is standing in front of the smart mirror 10. In other implementations, additional or alternative image sensors can be used. For example, the image data could be generated by an image sensor located in a user device, such as a smartphone, a tablet computer, a laptop computer, a separate camera, etc. This image data can be used in conjunction with image data generated by other image sensors (e.g., the camera 20), or used by itself.

The image data can be received in any suitable manner, and stored in any suitable memory device. For example, if the image data is generated by the camera 20 of the smart mirror 10, the camera 20 can be connected to the memory device 24 of the smart mirror 10, so that the image data can be stored in the memory device 24. If the image data (or additional image data) is generated by an external device (e.g., the user's smartphone), a communications interface can be used to receive the image data. For example, the smart mirror 10 may include a communications interface used to receive the image data, which can then be stored in the memory device 24. The communications interface can include a wireless communications interface (e.g., using an RF communication protocol, a Wi-Fi communication protocol, a Bluetooth communication protocol, over a cellular network, etc.) and a wired communications interface (e.g., an Ethernet port, a USB port, etc.).

Step 404 of method 400 includes analyzing the image data to determine a gesture performed by the user's hand (and/or a gesture performed by the object), to determine the identity of the object, or both. The analysis of the image data can be performed by any suitable processing device(s) or processor(s). For example, if the user is standing in front of the smart mirror 10, the image data can be analyzed by the one or more processors 22 of the smart mirror 10. Processors of other devices can also be used to analyze the image data. For example, some or all of the analysis can be done by one or more processors of a user device, such as a smartphone, a tablet computer, a laptop computer, etc.

Determining the identity of the object held in the user's hand can be accomplished using any suitable technique. For example, in some implementations, computer vision is used to determine the identity of the object. Edge detection can be employed to identify the shape of the object, and the color of the object can also be determined. The identity of the object can be determined based at least in part on the shape of the object and its color.

A variety of different gestures of the user's hand and/or the object being held in the user's hand can be identified by analyzing the image data. As used herein, the term “gesture” refers to the user's hand and/or the object undergoing a certain motion, being in a specific position, moving to and/or from a specific position, or any combination thereof. Thus, a gesture is generally considered to be a static gesture or a dynamic gesture. A static gesture generally refers to the position of the hand (which can include both the shape/orientation of the hand and the physical location of the hand in space relative to some frame of reference, as discussed in more detail herein), and thus may also be referred to as the position of the hand. A dynamic gesture includes some type of movement of the user's hand between different positions (which as noted, can include both the shape/orientation of the hand and the location of the hand). This movement can be between two different shapes/orientations, two different physical locations, or combinations of different shapes/orientations and physical locations. For example, a specific movement of the user's hand (e.g., moving the hand in a horizontal direction from left to right) may be considered a single gesture regardless of the shape/orientation of the hand, or could include multiple different gestures corresponding to different shapes/orientations that the hand may have when moving between the two locations (e.g., palm facing up vs. palm facing down, fingers extended vs. a clenched fist, etc.). Thus, a given gesture of the hand can include the hand being in a specific position, moving to a specific position, moving from a specific position, or any combination thereof.

In some implementations, a gesture can include movement of the hand of the user (and/or the object) in different directions. In one example, this movement includes linear movement of the hand (e.g., the hand moving left and right, the hand moving up and down, etc.). Gestures involving linear movement can include the user's hand moving linearly in different directions (e.g., the hand moving linearly in one direction can be a first gesture, the hand moving linearly in a second direction can be a second gesture, etc.).

In a second example, this movement includes circular movement of the hand (e.g., the hand moving in a clockwise direction or a counterclockwise direction). Generally, circular movement of the hand will involve the user's hand and arm moving in a circular direction. Gestures involving circular movement can include the user's hand moving circularly in different directions (e.g., the hand moving clockwise can be a first gesture, the hand moving counterclockwise can be a second gesture, etc.). Circular movement of the hand can include both the hand making full circles, and the hand making arcing movements (e.g., making partial circles).

In a third example, this movement includes rotational movement of the hand (e.g., the hand rotating in a clockwise direction or a counterclockwise direction). Generally, rotational movement of the hand will involve the user rotating their wrist while their arm stays stationary. Gestures involving rotational movement can include the user's hand rotating in different directions (e.g., the hand rotating clockwise can be a first gesture, the hand rotating counterclockwise can be a second gesture, etc.).

In some implementations, the distance that the hand (and/or the object) moves in a certain direction can be taken into account when determining whether the hand performed one or more gestures. For example, the hand moving linearly in a first direction for a first distance can be a first gesture, while the hand moving linearly in the same direction for a second distance can be a second gesture that is different than the first gesture. The amount of circular movement or rotational movement can also be used to distinguish between different gestures. For example, the hand moving circularly or rotating for a certain angular distance (e.g., a certain amount of degrees) can be a distinct gesture from one where the hand moves circularly or rotates for a different angular distance.

For example, the user's hand moving to the left side of the user's body (or being on the left side of the user's body) can be considered a distinct gesture from the user's hand moving to the right side of the user's body (or being on the right side of the user's body). Other examples of these types of gestures can include the hand moving to and/or being above or below the user's neck, the hand rotating to or being at a certain angle relative to a reference frame, and others.

In further examples, the hand of the user moving to and/or being in a generally open position (e.g., with all five fingers extended) can be considered a distinct gesture from the hand moving to and/or being in a generally closed position (e.g., the hand clenched into a fist). Other features of the hand can also be taken into account when determining the specific position. For example, different fingers being extended (or moving to an extended position) can be different gestures (e.g., only the index finger extended can be a first gesture, the index finger and the pink finger extended can be a second gesture, etc.).

In some cases, the movement of the hand to a certain location and the hand being in a certain position (e.g., a certain shape/configuration) are both taken into account in determining what gesture the hand has performed. For example, the user moving their hand above their head while the hand is clenched into a first (and/or the hand being above the head while the hand is clenched into a first) can be a distinct gesture from the user moving their hand above their head while the hand has all fingers extended (and/or the hand being above their head while the hand has all fingers extended). In another example, the user moving their hand to one side of their body while the palm is facing upwards (and/or the hand being on that side of the body while the palm is facing upwards) can be a distinct gesture from the user moving their hand to that same side of their body while the palm is facing downwards (and/or the hand being on that side of the body while the palm is facing downwards).

In some cases, the analysis of the image data shows the hand moving between a first position and a second position. For example, the image data may indicate that the hand was in the first position at a first time, in the second position at a second time, and at one or more intermediate positions between the first position and the second position at one or more times between the first time and the second time. In other cases, the movement between the first position and the second position can be inferred from the hand first being in the first position, and subsequently being in the second position. In a further example, the image data may only indicate that the hand was in the first position at a first time and in the second position at a second time, and movement from the first position to the second position is inferred if the second time is within a threshold time from the first time. Thus, if the analysis of the image data indicates that the hand was in the second position a short time (e.g., 1 second, 2 seconds, etc.) after being in the first position, it can be determined that the hand performed the specific gesture of moving from the first position to the second position. If the analysis of the image data indicates that the hand was in the second position a longer time (e.g., 10 seconds, 20 seconds, etc.) after being in the first position, it is not determined that hand performed the specific gesture of moving from the first position to the second position.

In some implementations, the gestures that the user's hand makes can be movements of the user's hand during the use of an object held by the user, such as a makeup brush, an eyebrow pencil, a razor, a comb, a hair brush, etc. Use of many of these types of objects including the user moving the object adjacent to various different portions of the user (e.g., portions of the user's face and/or skin). For example, the user using a makeup brush includes the user moving the makeup brush adjacent to different portions of the user's face, in order to apply makeup to those portions of the user's face. In another example, the user using a razor includes the user moving the razor adjacent to different portions of the user's face, in order to remove hair from those portions of the user's face. In general, the user moving an object adjacent to various portions of the user's face (and/or other portions of the user) can include the object contacting portions of the user, the object being in close proximity to portions of the user (e.g., within about one inch of the user's skin), the object being further away from portions of the user but still moving adjacent to those portions, or any combination thereof (for example, as the user uses the razor, movement of the user's hand can be tracked both during actual strokes of the razor against the user's skin, and during movement of the razor between strokes).

The image data can be analyzed to monitor movement of the user's hand as the user uses the object. In some of these implementations, the image data is analyzed to determine the portion of the user that the object has been moved adjacent to (e.g., has had makeup applied thereto, has had hair removed therefrom, etc.). This determination could be broad, and include only determining which side of the user's face that the object has been moved adjacent to. This determination could be narrower however, and include determining whether the object has been moved adjacent to narrower portions of the user's face, such as left cheek, right cheek, forehead, chin, neck, upper lip, etc.

In one example, if the user is using a makeup brush, the image data can be analyzed to track the movement of the user's hand that is holding the makeup brush and determine which portions of the user's face the makeup brush has moved adjacent to (e.g., which portion of the user's face has had makeup applied thereto). In some cases, this determination can include determining what percentage of the desired area the object has been moved adjacent to. For example, if the user is using a makeup brush to apply makeup to their face (or a portion of the face), the image data can be analyzed to determine what percentage of the user's face (or what percentage of the portion of the user's face) makeup has been applied to with the makeup brush.

The image data can also be analyzed to monitor movement of the user's hand adjacent to various portions of the user (e.g., the user's face) when the user is not holding an object in their hand. For example, if the user is massaging their face, movement of the user's hand can be monitored to determine areas of their face the user has massaged, what types of movements the user is using to massage their face, etc. In another example, the user may use their fingers to apply makeup or another substance directly to their skin. During this application, movement of the user's hands can be monitored to determine areas of their face where the makeup has been applied.

Moreover, the image data can also be analyzed to determine if the object and/or the user's hand make contact with the user's skin, as the object and/or the user's hands are moving adjacent to the user's skin. For example, if the user is using a makeup brush, in addition to analyzing the image data to monitor movement of the makeup brush adjacent to the user's face, the image data can also be analyzed to determine if the makeup brush contacted the user's face when adjacent to the various portions of the face, to determine if makeup was actually applied to those portions of the user's face. A variety of different techniques can be used to detect skin contact. For example, the image data can be analyzed to determine if shadows on the skin caused by the user's hand and/or the object indicate that contact was made. In another example, the image data can be analyzed to determine if the skin adjacent to the user's hand and/or the object has been deformed due to contact between the skin and the user's hand and/or the object. In a further example, a depth camera can be used to determine if the user's and and/or the object contacted the user's skin.

In some implementations, one or more machine learning algorithms are used to analyze the image data and determine the gestures performed by the user's hand and/or the object held in the user's hand, and/or to identify the object. Generally, the image data can be reproduced as a plurality of image frames (e.g., consecutive images). The machine learning algorithm is trained to analyze one or more of the images frames and determine how the hand moves across the image frames, in order to identify any gestures performed by the hand and/or the object.

In some implementations, the machine learning algorithm analyzes the image data to identify a number of positional characteristics of the hand of the user and/or the object. The positional characteristics can include the locations of various different landmarks that have been identified within each image frame, and can additionally or alternatively include other characteristics. Any number of landmarks can be used. In some implementations, the landmarks that can be used include the tip of any of the fingers (thumb, index finger, middle finger, ring finger, and pinky finger); the base of any of the fingers (also referred to as the metacarpophalangeal joint of any of the fingers); the middle knuckle of the thumb (also referred to as the proximal interphalangeal joint of the thumb); the lower middle knuckle of the index finger, middle finger, ring finger, or pinky finger (also referred to as the proximal interphalangeal joint of these fingers); the upper middle knuckle of the index finger, middle finger, ring finger, or pinky finger (also referred to as the distal interphalangeal joint of these fingers); the palm of the hand; the back of the hand; the wrist (which could include the radiocarpal joint, the carpometacarpal joints of any of the fingers, or both); other landmarks; or any combination of these landmarks. The machine learning algorithm can analyze each image frame and determine the position of any one or more of these landmarks. Generally, the position of the landmarks will be determined relative to some reference point with the image frame, such as the center of the image frame, one of the corners of the image frame, etc. In these examples, the position of each landmark could be defined by a set of coordinates, which could be a two-dimensional set of coordinates with the image frame (e.g., horizontal distance and vertical distance), but could also be a three-dimensional set of coordinates that includes a depth coordinate.

The landmarks could also include landmarks associated with the object. For example, the landmarks could include a proximal end of the object, a distal end of the object, a midpoint of the object, landmarks about the periphery of the object, and others. Specific types of objects may have distinct landmarks. For example, a brush (e.g., a makeup brush, a hair brush, etc.) may include landmarks associated with the bristles, while other objects without bristles would not have such landmarks.

The positional characteristics can include other features as well. For example, in some cases, the positional characteristics can include one or more Euler angles associated with the hand, one or more quaternions associated with the hand, and other characteristics. The positional characteristics can also include the angle of the user's palm, which could be defined relative to any suitable axis, such as an axis connecting the base of the palm and the base of the any of the fingers, an axis connecting the base of the index finger and the base of the pinky finger, etc. These characteristics are generally associated with rotation of the hand, and can be determined for each frame, for each set of consecutive frames, or over any suitable time period.

In some implementations, the positional characteristics can be determined from data other than the imaging data. For example, if the user is wearing a smartwatch with motion sensors (such as an accelerometer, a gyroscope, a magnetometer, etc.), motion data generated by the motion sensors can be analyzed by the machine learning algorithm. The motion data can be used to determine positional characteristics such as Euler angles and/or quaternions, and/or other positional characteristics. In some cases, certain positional characteristics can be based on both image data and motion data.

Based on the various positional characteristics determined for the hand and/or the object, the machine learning algorithm can determine movement of the hand and/or the object can be determined. For example, the change in coordinates of the various landmarks can be determined across two or more image frames to determine the movement of those landmarks across the two or more image frames. Other positional characteristics can also be analyzed to determine movement of the hand and/or the object across time.

Finally, based on the movement of the hand and/or the object across two or more images frames, the machine learning algorithm can determine one or more gestures performed by the hand and/or the object. In some implementations, the machine learning algorithm generates the probability that the hand and/or the object performed a specific gesture within a certain time frame. For example, the machine learning algorithm may be trained to detect five different gestures, and can output the probability that each of these five gestures was performed in a given time frame. Thus, the machine learning algorithm can generate one or more gesture probabilities, where each gesture probability is the probability that the hand and/or the object performed a respective gesture.

Generally, the machine learning algorithm analyzes the image data in groups of image frames, to determine if the hand performed a gesture during the time period corresponding to each distinct group of image frames. In some implementations, the number of image frames within each group of image frames is at least 10 frames, at least 30 frames, at least 50 frames, at least 60 frame, or at least 100 frames. In some implementations, the machine learning algorithm analyzes image frames that correspond to distinct amounts of time. The amount of time associated with each group of image frames can be 0.1 seconds, 0.25 seconds, 0.5 seconds, 1 second, 3 seconds, 5 second, 10 seconds, etc.

In some implementations, the machine learning algorithm includes multiple layers that perform different types of analysis on the image data. In some of these implementations, the machine learning algorithm includes four layers. The first layer is configured to receive the image data (or a portion of the image data) and determine, for each of at least two image frames, the value of a positional characteristic of the hand and/or the object. As discussed herein, the positional characteristics can include the position of various landmarks of the hand and/or object for each image frame, but can include other quantities such as Euler angles, quaternions, etc. In some implementations, the first layer also receives motion data, which is also used to determine the value of various quantities. Thus, the first layer of the machine learning algorithm is a pre-processing layer that performs the initial analysis of the image data.

The second layer of the machine learning algorithm is configured to convert individual positional characteristics for each image frame into stacked features that represent the change in the positional characteristics over time. For example, the second layer can take the individual coordinates of the landmarks from the first layer and convert them into overall movement of each of the landmarks over the time period being analyzed. Thus, the second layer of the machine learning algorithm is a feature-stacking layer.

The third layer of the machine learning algorithm includes a neural network that receives as input the stacked features, and outputs one or more gesture probabilities (e.g., the probability that the hand and/or the object performed a distinct gesture during the time period or the image frames being analyzed). Any suitable types of neural networks can be used, such as a multi-layer convolutional neural network, a recurrent neural network, a hidden Markov model, a long short-term memory model, etc.

In some implementations, the neural network includes multiple layers. The first layer of the neural network includes a 2D convolution with a kernel size of [1,1] to integrate the spatial dimensions along a number of channels. The second layer of the neural network includes a 2D convolution with a kernel size of [N_{f}, 1] to integrate the channels from the first layer along the feature axis, where N_{f} is the number of individual positional char being analyzed. The third layer of the neural network includes a 2D convolution with a kernel size of [1, k] to integrate all of the data along the time axis to analyze the evolution of the positional characteristics over time. k can be any integer, but generally has a value of 3, 4, or 5. A normalization layer can be placed between the first layer of the neural network and the second layer of the neural network, and/or between the second layer of the neural network and the third layer of the neural network, in order to stabilize the inputs into the next layer of the neural network. The neural network may also include sets of 2D convolution layers and pooling layers to assess the output. These sets can include a first set of layers and a second set of layers. The first set of layers includes a 2D convolution layer with a kernel size of [1,1] and a stride size of [1,1] or [2,2]. The second set of layers includes a first 2D convolution layer with a kernel size of [1,1] and a stride size of [1,1], a second 2D convolution layer with a kernel size of [3,3] and a stride size of [1,1], a third 2D convolution layer with a kernel size of [1,1] and a stride size of [1,1], and a max pooling layer with a stride size of [1,1] or [2,2].

In some implementations, specific positions of the hand (e.g., specific static gestures) can be defined using specific sets of distances (or ranges of distances) between various landmarks. The neural network can thus be trained to determine the distances between one or more of the landmarks for each image frame, and to output the gesture probabilities for each image frame. The closer that the calculated landmark distances for a given image frame are to the defined distances/ranges of distances for a specific position, the higher the gesture probability for that specific position will be for the image frame. In some implementations, the static gesture for each image frame is the static gesture having the highest gesture probability for that image frame.

The neural network can then analyze the gesture probabilities for multiple image frames to determine if the hand performed a dynamic gesture. For example, in some implementations the gesture probabilities for a set of image frames containing a plurality of image frames are analyzed to determine if a dynamic gesture was performed within that set of image frames. Generally, each dynamic gesture will have a defined start position and end position. If it is determined that the hand was in the start position for a certain dynamic gesture during at least one image frame within the set of image frames, and was in the end position for that dynamic gesture during at least one subsequent image frame within the set of image frames, the neural network can determine that the hand performed that dynamic gesture during the set of image frames.

If no dynamic gesture is detected for the set of image frames, the neural network can determine that the hand performed one or more static gestures within the set of image frames (e.g., the hand was in one or more positions within the set of image frames). In some implementations, when no dynamic gesture is detected within a set of image frames, the neural network selects the static gesture that has the highest frequency within the set of image frames (e.g., the static gesture that was determined to be the static gesture for the most number of image frames within the set of image frames).

In other implementations, the neural network may not determine gesture probabilities for each individual image frame. Instead, the static gesture for each respective image frame can be determined as the static gesture that the position of the hand is closest to for the respective image frame. The neural network can then determine that a specific dynamic gesture was performed within each respective set of image frames, and/or output gesture probabilities for each respective set of image frames. For each respective set of image frames, each gesture probability is the percentage of image frames within the respective set of image frames where a given one of the static gestures was determined to be the static gesture for that image frame.

The fourth layer of the machine learning algorithm can perform post-processing on the gesture probabilities received from the third layer. In some implementations, the fourth layer is used to filter out potentially faulty gesture probabilities. For example, in order to fully determine that the hand has performed a certain gesture, it may be required that n consecutive outputs of third layer of the machine learning algorithm have that certain gesture with the highest gesture probability. If any given output of the third layer does not satisfy this condition for a gesture, the fourth layer can prevent the machine learning algorithm from fully determining that the hand has performed that specific gesture. In some implementations, the third layer of the machine learning algorithm (e.g., the neural network) determines the static gesture (and/or gesture probabilities for each image frame), and the fourth layer of the machine learning algorithm performs the filtering above to determine the static and/or dynamic gesture for each image frame and/or set of image frames.

Determining gestures of the hand in this manner is rotation-invariant. And because the distances can be normalized, the determination of the gestures of the hand can also be scale-invariant and translation-invariant. Further, while a trained machine learning algorithm can be used to determine gestures as discussed above, the landmark distances can be directly determined and analyzed in order to determine gestures performed by the hand without the use of any machine learning

In some implementations, landmark distances can be used to define the generally open position of the hand and the generally closed position of the hand. In one example, the generally open position of the hand can be defined to include positions where (i) all fingers (including or excluding the thumb) are in a raised position (e.g., extended outward away from the palm), (ii) the palm is visible in the image data, (iii) the tip of the thumb is below the tip of the index finger, or (iv) any combination of (i)-(iii). In a second example, the generally open position of the hand can be defined to exclude positions where (i) one or more fingers are in a lowered position (curled inward toward the palm), (ii) the palm is not visible in the image data, (iii) the tip of the thumb is not below the tip of the index finger, or (iv) any combination of (i)-(iii). In a third example, the generally closed position can be defined to include positions where (i) all fingers (including or excluding the thumb) are in the lowered position, (ii) the palm is visible in the image data, (iii) the tip of the thumb is above the tip of the index finger, or (iv) any combination of (i)-(iii). In a fourth example, the generally closed position can be defined to exclude positions where (i) one or more fingers are in the raised position, (ii) the palm is not visible in the image data, (iii) the tip of the thumb is not above the tip of the index finger, or (iv) any combination of (i)-(iii).

In some implementations, determining whether a finger is in the raised position or the lower position can be based on the landmark distances. For example, the position of landmarks corresponding to the base of a finger and the tip of that finger along an axis extending outward from the palm can be compared. If the tip of the finger is closer to the origin of the axis (e.g., closer to the palm), than the finger is in a lowered position, and if the base of the finger is closer to the origin of the axis, than the finger is in a raised position. This technique can also be used to determine whether the tip of the thumb is above or below the tip of the index finger. If the tip of the thumb is closer to the origin of the axis (e.g., closer to the palm), then the tip of the thumb is lower than the tip of the index finger. Conversely, if the tip of the index finger is closer to the origin of the axis (e.g., closer to the palm), then the tip of the thumb is higher than the tip of the index finger.

In some implementations, determining whether the palm is visible in the image data can also be based on the landmark distances. For example, the state of the palm being visible can be defined as when the distance between the tip of the thumb and the tip of the pinky finger is less than the distance between the base of the index finger and the base of the pinky finger. Conversely, the state of the palm not being visible can be defined as when the distance between the tip of the thumb and the tip of the pinky finger is greater than the distance between the base of the index finger and the base of the pinky finger. Thus, by determining the distances between these landmarks, it can be determined whether the palm is visible in the image data.

Thus, step 404 can include determining any number of static and/or dynamic gestures that the user's hand and/or the object held in the user's hand performed during whatever time period is being analyzed. The static gestures can include the hand being in a certain position, which could include the hand being in a certain orientation and/or shape, and/or the hand being in a certain physical location. These different orientations and/or shapes can include fingers extended; fingers clenched into a fist; the wrist extended; the wrist flexed; the hand making the “ok” symbol (e.g., the tips of the thumb and index finger touching, and the remaining fingers in a raised position extending outward from the palm) with the palm and/or the extended fingers facing various different directions (e.g., away from the user, toward the user, left, right, up down, etc.); the “victory” symbol (e.g., the index and middle fingers in the raised position, and the thumb, ring finger, and pinky finger in a lowered position) with the palm and/or the extended fingers facing in various different directions (e.g., away from the user, toward the user, left, right, up down, etc.); having a single finger (including the thumb) extended with the palm and the extended finger facing in various different directions (e.g., away from the user, toward the user, left, right, up down, etc.); other shapes/orientations; or any combination of shapes/orientations. The hand being in a certain physical location can include above the head, to the left side of the user's body, to the right side of the user's body, etc. Static gestures can also include the object held in the user's hand being in a certain orientation and or shape, being in a certain physical location, and others. Dynamic gestures can generally include any movement of the hand, including linear movement, circular movement, rotational movement, movement between different orientations/shapes, etc. Dynamic gestures can also include any movement of the object held in the user's hand.

Referring back to FIG. 4, step 406 of the method 400 includes modifying the execution of one or more applications that are being executed by the one or more processors, based at least in part on the one or more gestures that the hand and/or object has performed, the identity of the object, or both. As discussed herein, the smart mirror 10 can be used to execute applications that can assist the user in shaving, applying makeup, etc. The processor 22 can be used to execute these applications, which can include displaying a variety of different objects on the display 14 of the smart mirror 10. Step 406 includes modifying the execution of these applications in a variety of different ways, based on gestures performed by the hand and/or the object, and/or the identity of the object.

Any number of modifications can occur based on gestures and/or the identity of the object. Modifying the execution of the one or more applications can include launching an application; terminating an application; switching between different applications; navigating within an application (e.g., navigating through various menus of the application); adjusting one or more settings of an application; adjusting a size, position, or orientation of any object displayed on the display 14 as part of the application; causing certain information, text, objects, etc. to be displayed on the display 14; and other modifications.

Generally, different gestures can cause different modifications to occur. In some implementations, opposing gestures can be used to cause opposing modifications to occur. For example, the user moving their hand between two different positions can cause two different modifications to occur. The user moving their hand in a first direction from a first position to a second position can cause a first modification to occur, while moving their hand in a second opposing direction from the second position to the first position can cause a second modification to occur.

As noted herein, the modification to the execution of the one or more applications can be based on gestures detected via analysis of the image data. In some implementations, the modification can include launching a specific application based on the gestures of the hand. For example, if the one or more gestures are associated with a makeup implement (such as a makeup brush or an eyebrow pencil), then a make-up related application can be launched. In another example, if the one or more gestures are associated with a razor, then a shaving-related application can be launched. Other types of modifications can also be made based on what object the one or more gestures of the user's hand show that the user is using.

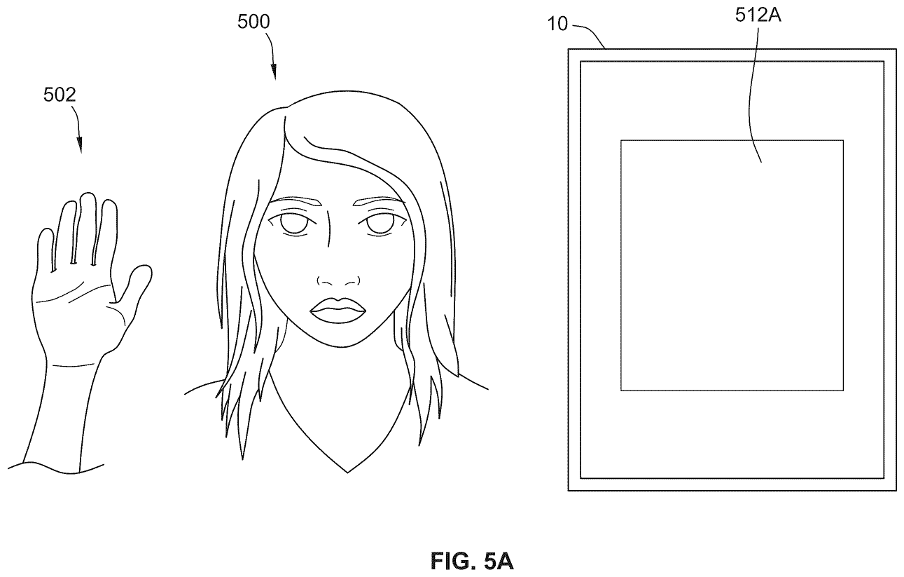

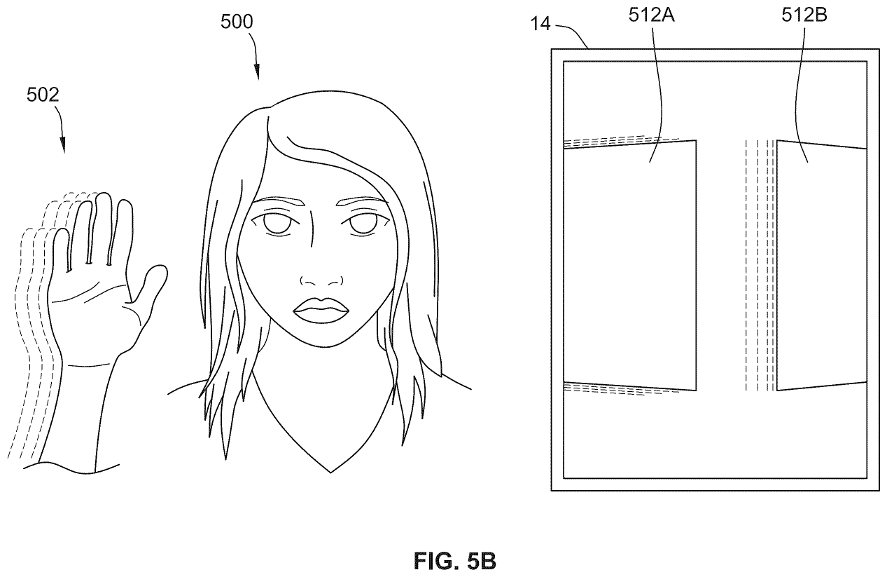

FIGS. 5A and 5B shows an example of a user 500 moving their hand 502 in order to switch between different applications being shown on the display 10 of the smart mirror 10. In FIG. 5A, an application 512A is being executed by the processor 22, and is shown on the display 14. In FIG. 5B, the user 500 has moved their hand 502 horizontally. The processor 22 analyzes image data generated by the camera 20 to determine that the hand 502 of the user 500 performed this gesture. The processor 22 then modifies execution of the application 512A by switching from application 512A to application 512B. As shown in FIG. 5B, application 512A begins to disappear from the display 14, while application 512B begins to appear on the display 14.

Thus, the smart mirror 10 is able to detect the gesture performed by the hand 502 of the user 500 (horizontal motion), and respond by switching between different applications. In some cases, the user 500 can make the opposite gesture (e.g., moving their hand 502 in a horizontal direction back to its original position) to switch back to application 512A. While FIGS. 5A and 5B illustrate the gesture to switch applications as horizontal motion of the hand 502, any suitable gesture or gestures can be used to switch between applications. Further, while the illustrated implementation shows a gesture comprising horizontal movement being used to switch between applications, such a gesture could be used to modify the execution of the one or more applications in other manners as well.

In general, the hand moving between a first position to a second position can be used to switch between different applications. In some implementations, the hand moving in a first linear direction between the first position and the second position switches from a first application to a second application, and the hand moving in a second linear direction that is parallel to and opposite from the first direction switches from the second application to the first application. Movement between the first position and the second position can include the linear horizontal movement as shown in FIGS. 5A and 5B, but can include other types of movements as well, such as other types of linear movement (e.g. diagonal), rotational movement, circular movement, arcing movement, movement between an open position and a closed position, etc.

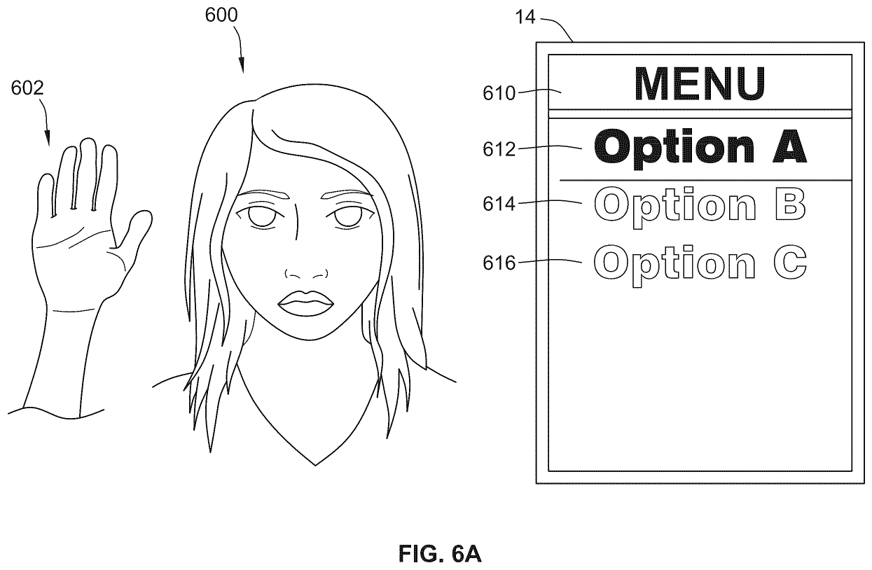

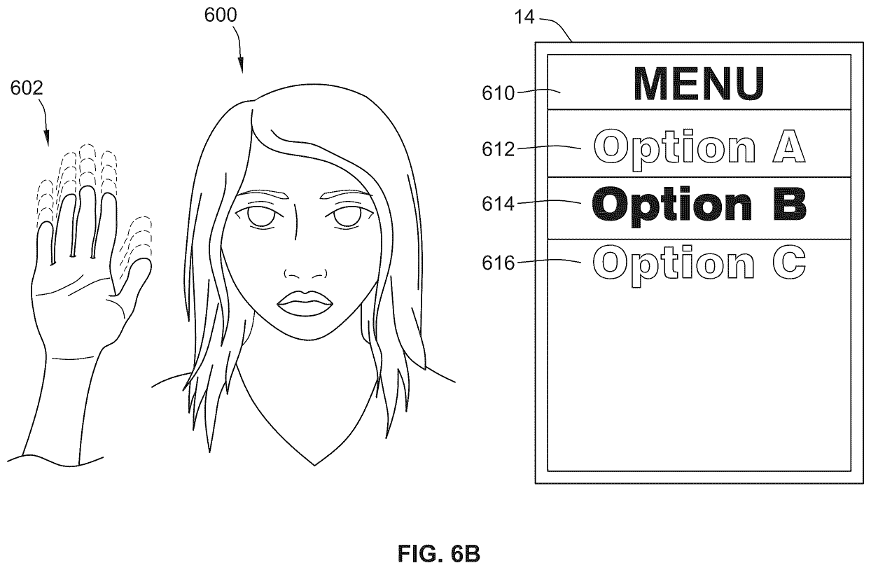

FIGS. 6A and 6B shows an example of a user 600 moving their hand 602 in order to navigate within the application that is being executed by the processor 22 and shown on the display 10. In FIG. 6A, the menu 610 of the current application is shown on the display 14, along with a first option 612 (shown as “Option A”), a second option 614 (shown as “Option B”), and a third option 616 (shown as “Option C”). Each of these options can be selected as part of navigating through the menu 610 of the current application. Selecting one of these options could lead to a further sub-menu, allow the user 600 to adjust the value of a setting of the application, activate a pre-defined feature of the application, etc. As shown in FIG. 6A, the first option 612 is the currently highlighted option, and would be selected if the user 600 indicated as such (for example, by performing a certain gesture, or otherwise providing input to the smart mirror 10 indicating such a selection).

In FIG. 6B, the user 600 has moved their hand 602 downward (e.g., vertically). The processor 22 analyzes image data generated by the camera 20 to determine that the hand 602 of the user 600 performed this gesture. The processor 22 then modifies execution of the application currently being executed by un-highlighting the first option 612, and highlighting the second option 614. Now, the second option 614 would be selected if the user 600 indicated as such.

Thus, the smart mirror 10 is able to detect the gesture performed by the hand 602 of the user 600 (horizontal motion), and respond by navigating through the menu 610 of the current application. In some cases, the user 600 can make the opposite gesture (e.g., moving their hand 602 in a vertical direction back to its original position) to navigate back up to the first option 612. The user 600 could also navigate down to the third option 616 by further moving their hand downward in a vertical motion. While FIGS. 6A and 6B illustrate the gesture as vertical motion of the hand 602 to navigate through the menu of the current application, any suitable gesture or gestures can be used to navigate through the menu of the current application. Further, while the illustrated implementation shows a gesture comprising vertical movement being used to navigate through the menu of the current application, such a gesture could be used to modify the execution of the one or more applications in other manners as well,

In general, the hand moving between a first position to a second position can be used to navigate within the current application. In some implementations, the hand moving in a first linear direction between the first position and the second position navigates in a first direction (e.g., scrolls downward within the current menu), and the hand moving in a second linear direction that is parallel to and opposite from the first direction navigates in a second direction (e.g., scrolls upward within the current menu). Movement between the first position and the second position can include the linear vertical movement as shown in FIGS. 6A and 6B, but can include other types of movements as well, such as other types of linear movement (e.g. diagonal), rotational movement, circular movement, arcing movement, movement between an open position and a closed position, etc.

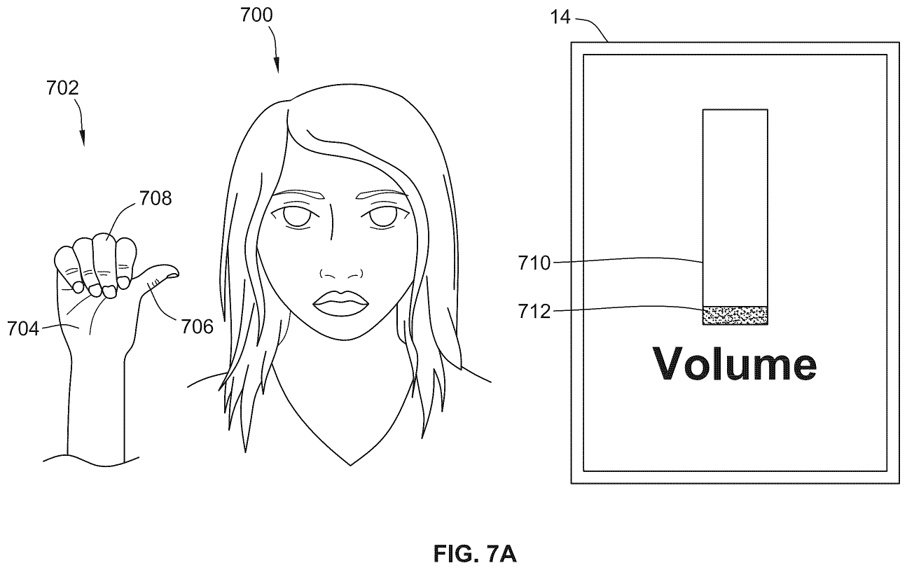

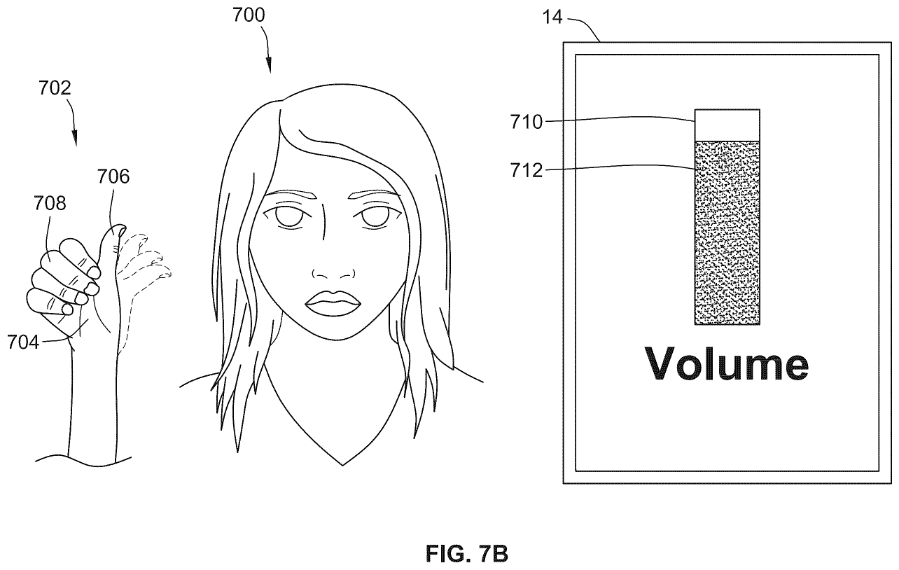

FIGS. 7A and 7B shows an example of a user 700 moving their hand 702 in order to adjust one or more settings of an application being executed by the processor 22 of the display 10 of the smart mirror 10. In FIG. 7A, the display 14 shows both a bar 710 representing the full range of values of the volume setting, and a current value indicator 712, indicating the current value of the volume setting. In FIG. 7A, the user 700 has their hand 702 with the palm 704 facing outward, the fingers 706 curled, and the thumb 708 extending outward to the side.

In FIG. 7B, the user 700 has rotated moved hand 702 so that the thumb 708 faces upward, while the palm 704 remains facing outward and the fingers 706 remain curled. The processor 22 analyzes image data generated by the camera 20 to determine that the hand 702 of the user 700 has performed this gesture. The processor 22 then modifies execution of the application being executed by adjusting the value of the volume setting. In the illustrated example, the gesture performed by the hand 702 of the user 700 causes the volume to increase, which is shown by the current value indicator 712 growing larger and filling up a larger portion of the bar 710.

Thus, the smart mirror 10 is able to detect the gesture performed by the hand 702 of the user 700 (rotational motion), and respond by adjusting the value of the volume setting. In some cases, the user 700 can make the opposite gesture (e.g., rotating their hand 702 back to its original position) to decrease the volume. While FIGS. 7A and 7B illustrate the gesture as rotational motion of the hand 602, any suitable gesture or gestures can be used to adjust the value of the volume setting, and/or adjust the value of any other settings. Further, while the illustrated implementation shows a gesture comprising rotational movement being used to adjust settings of an application, such a gesture could be used to modify the execution of the one or more applications in other manners as well.

In general, the hand moving between a first position to a second position can be used to adjust the value of a setting within an application. In some implementations, the hand moving in a first rotational direction between the first position and the second position adjust the value of the setting in a first direction (e.g., increases the volume, increases the brightness, etc.), and the hand moving in a second rotational direction that is opposite from the first rotational direction adjusts the value of the setting a second direction (e.g., decreases the volume, decrease the brightness, etc.). Movement between the first position and the second position can include the rotational movement as shown in FIGS. 7A and 7B, but can include other types of movements as well, such as linear movement, circular movement, arcing movement, movement between an open position and a closed position, etc.

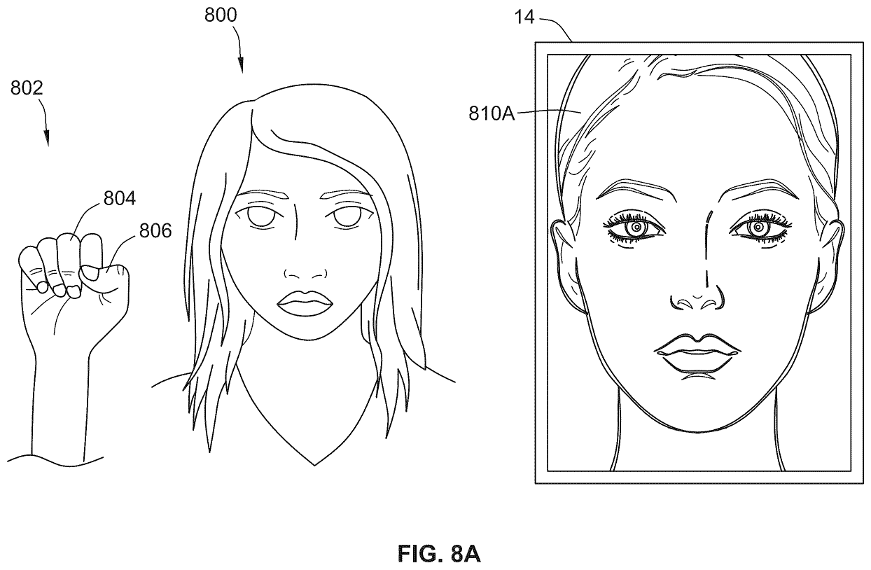

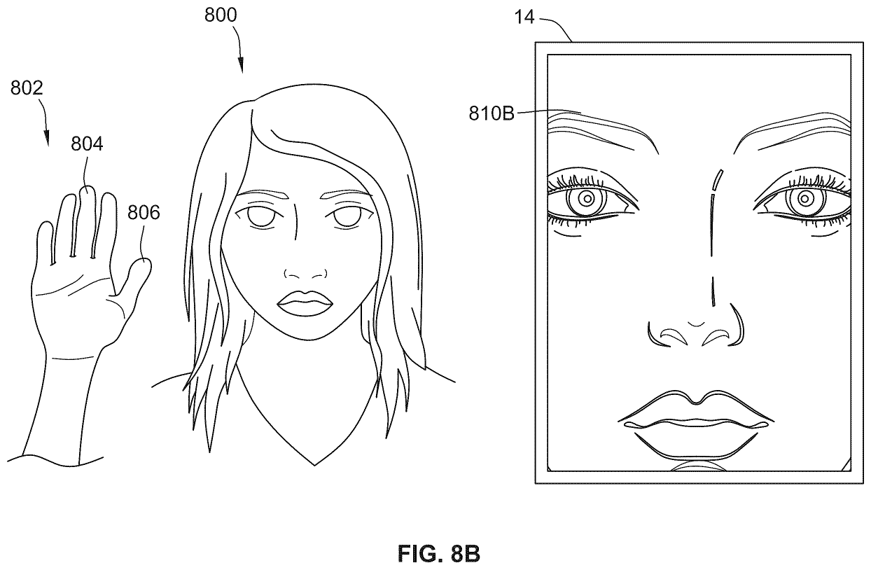

FIGS. 8A and 8B shows an example of a user 800 moving their hand 802 in order to modify an object that is shown on the display 14 as part of the application currently being executed. In FIG. 8A, an object 510 is shown on the display 14. In the illustrated example, the object is an image 810A of a human face. However, the image 810A could show any suitable object, such as an image of the user 800's face, an image of a piece of jewelry the user 800 is deciding whether to purchase and/or wear, etc. In FIG. 8A, the hand 802 of the user 800 is in a generally closed position. In the generally closed position, the hand 802 is clenched into a fist, with the fingers 804 and the thumb 806 all curled inward.

In FIG. 8B, the user 800 has moved their hand 802 from the generally closed position to a generally open position. In the generally open position, the hand 802 has the fingers 804 and the thumb 806 extended outward. The processor 22 analyzes image data generated by the camera 20 to determine that the hand 802 of the user 800 performed this gesture. The processor 22 then modifies execution of the application by showing a zoomed-in image 810B of the human face.

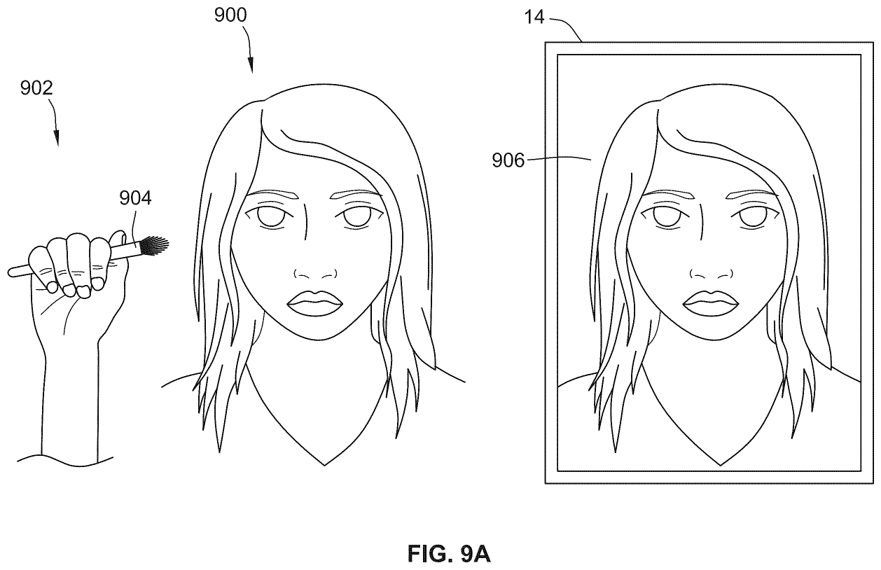

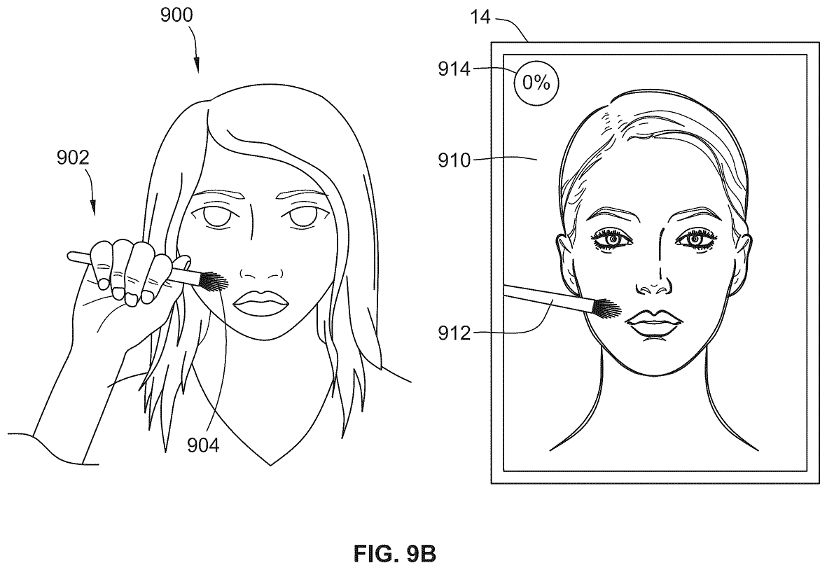

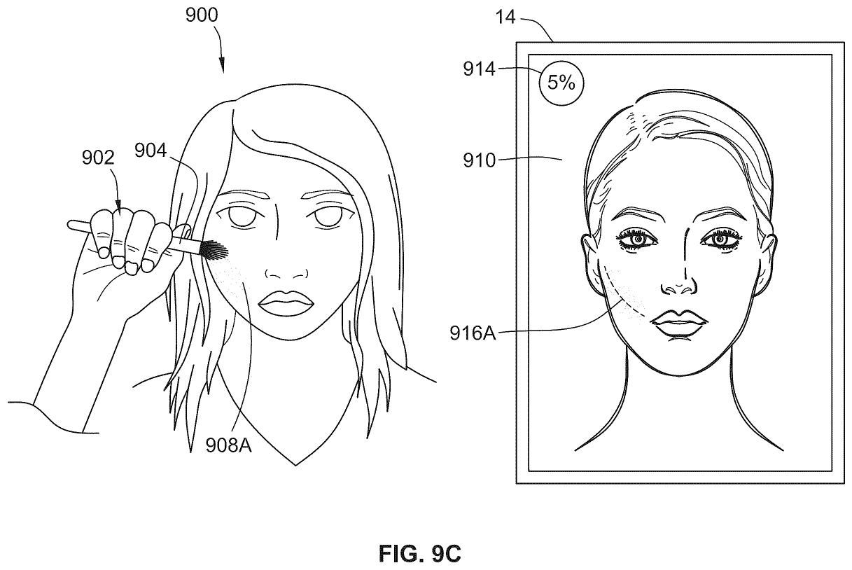

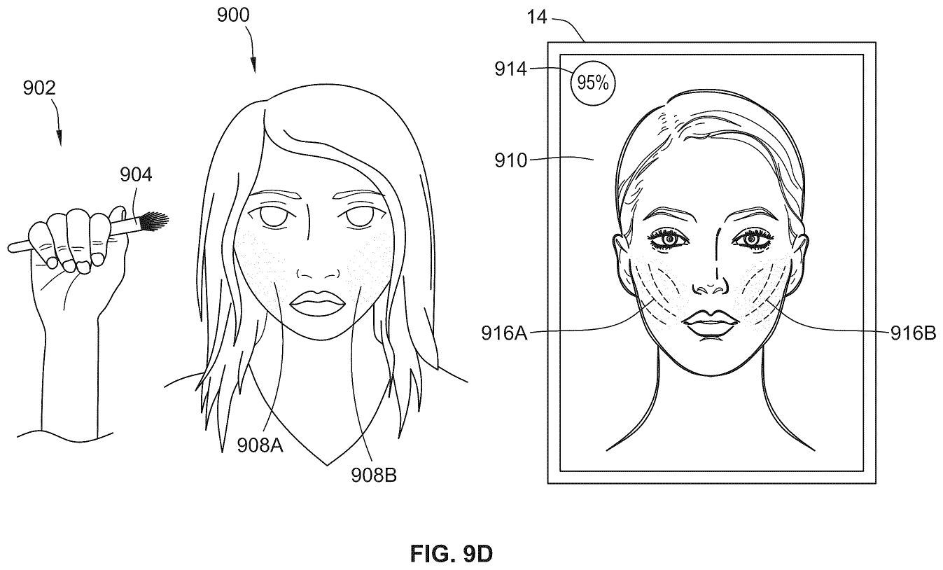

Thus, the smart mirror 10 is able to detect the hand 802 of the user 800 moving from the generally closed position to the generally open position, and respond by zooming in on the object currently being shown on the display 14. In some cases, the image 810A shown in FIG. 9A can be the “standard” size of the object, and the user 800 zooms in by moving their hand 802 to the generally open position. The user can move their hand 802 from the generally open position back to the generally closed position in order to zoom out on the object, e.g., to again show the “standard” size image 810A of the human face. In some cases however, if the display 14 is currently showing image 810A, the user 800 can move their hand 802 from the generally closed position to the generally open position in order to show a further zoomed-out version of the object. The user can move their hand 802 from the generally closed position back to the generally open position in order to zoom in on the object, e.g., to again show the “standard” size image 810A of the human face.

While FIGS. 8A and 8B illustrate the gesture to zoom in and out on an object shown on the display 14 as moving the hand 802 between the generally open position and the generally closed position, any suitable gesture or gestures can be used to zoom in and out on the object. Further, while the illustrated implementation shows a gesture comprising moving between the generally open position and the generally closed position being used to zoom in and out on the object shown on the display 14, such a gesture could be used to modify the execution of the one or more applications in other manners as well.

In general, the hand moving from a first position to a second position can be used to increase the size of a displayed object (e.g., from a first size to a second size larger than the first size), and moving from the second position to the first position can be used to decrease the size of the displayed object (e.g., from the second size to the first size). Movement between the first position and the second position can include movement between the generally closed position and the generally open position as shown in FIGS. 8A and 8B, but can include other types of movements as well, such as linear movement, rotational movement, circular movement, arcing movement, etc. In some implementations, the size of the object is only modified between the two sizes. In other implementations, the modification can include gradually increasing and decreasing the size of the displayed object as the hand moves between the first positon and the second position (e.g., the size of the displayed object will be an intermediate size between the first size and the size, in response to the hand moving to an intermediate position between the first position and the second position).

FIGS. 9A-9D show an example of a user 900 holding an object (in the illustrated example, a makeup brush 904) in their hand 902, while the movement of the hand 902 is monitored and the result is shown on the display 14. In FIG. 9A, the user 900 is holding the makeup brush 94 in their hand 902 and standing in front of the display 14, while an un-altered version 906 of the user 900 is visible. The un-altered version 906 of the user 902 can be an image that is shown on the display 14 itself, or could be the reflection of the user 902 on the mirror 12.

In FIG. 9B, the processor 22 of the smart mirror 12 has analyzed the image data to detect that the user 900 is holding the makeup brush 904 in their hand 902, and has launched a makeup application. As part of the makeup application, the display 14 shows a digital representation 910 of the user 900 (e.g., an image of the user 900, a pre-recorded video of the user 900, a real-time and/or delayed video of the user 900, or any combination thereof), and digital representation 912 of the makeup brush 904 (e.g., an image of the makeup brush 904, a pre-recorded video of the makeup brush 904, a real-time and/or delayed video of the makeup brush 904, or any combination thereof). The display 14 also shows a progress indicator 914, which indicates how much of the desired area of the user 900 (e.g., the user 900's face) the makeup brush 904 has been moved adjacent to (e.g., how much of the desired area of the user 900's face that makeup has been applied to using the makeup brush 904). In FIG. 9B, the progress indicator 914 shows 0%, because the user 900 has not begun to use the makeup brush 904.

FIG. 9C shows the user 900 moving their hand 904 adjacent to one side of their face, such that a first amount of makeup 908A has been applied to that side of the user 900's face. The processor 22 analyzes the image data that is generated during the user 900's use of the makeup brush 906 in order to track the movements of the makeup brush 906 relative to the user 900's face. In response, the display 14 shows a first set of one or more markers 916A that are overlaid on the representation 910 of the user 900's face, in an area corresponding to where the makeup was actually applied to the user's face. Thus, by analyzing the image data, the processor 22 can monitor movements of the user 900's hand 902, and cause the user 900's progress to be shown on the display. The progress indicator 914 can also be updated as the movement of the user 900's hand 902 is tracked. In FIG. 9C, the progress indicator 914 has been updated to show 5%.

In FIG. 9D, the user 900 has continued to use the makeup brush 906 and has moved the makeup brush 904 adjacent to a second side of the user's face, such that a second amount of makeup 908B has been applied to the second side of the user 900's face (in addition to the first amount of makeup 908A). The display 14 continues to show the first set of one or more markers 916A, and has been updated to also show a first set of one or more markers 916B on the opposite side of the digital representation 910 of the user 900's face. The progress indicator 914 has also been updated to indicate that the user 900 is 95% done applying makeup. In some implementations, the image data is also analyzed to confirm that the makeup brush 904 actually contacted the user 900's face, as discussed herein.

In FIGS. 9C and 9D, the markers 916A and 916B are shown as dots. However, the markers 916A and 916B could generally have any size and/or shape, and could include lines, squares, x's, circles, etc. The markers 916A and 916B could also include outlines of the areas adjacent to which the object has been moved, instead of indicating the entire area. In addition to the markers 916A and 916B, the areas where makeup has been applied (e.g., the areas adjacent to which the object has been moved) can be indicated in other ways. For example, in some implementations, the areas of the user 900's face to which the user 900 has applied makeup can be highlighted on the digital representation 910 on the display 14. This highlighting could be accomplished by slightly changing the color of the digital representation 910, by increasing the brightness of portions of the display 14, etc. Moreover, once it is determined that the user 900 has finished applying makeup, the display 14 can show an indication that the user 900 has finished. In some implementations, the progress indicator 914 is used for this function, and is updated to show 100%. In some implementations, it is determined that the user 900 has finished applying makeup once it is determined that the portion of the user 900 adjacent to which the makeup brush 904 has been moved (e.g., the portion of the user 900 to which makeup has been applied) is equal to at least some target percentage of the desired area). In some implementations, the display 14 could also show a zoomed-in view of the area of the user 900's face (and/or the area of the representation 910 of the user 900's face) where the makeup brush 906 is currently located and/or being moved adjacent to. Moreover, while FIGS. 9A-9D show these features in relation to the makeup brush 904, these features can be implemented during the user's use of any suitable object, including other makeup implements (e.g., eyebrow pencils, makeup cleaning wipes, eyelash curlers, lipstick, etc.), a razor (including an electric razor and a non-electric razor), a comb, a hairbrush, etc.

The features shown in FIGS. 9A-9D can be used to provide real-time coaching to the user as part of a tutorial video. For example, after a user picks up a makeup brush (or other object), a tutorial application can be launched, for example using the smart mirror 10. The tutorial application could display images and/or videos on the display 14 to the user showing the user how to use the makeup brush. The display 14 could then show a representation of the user's face, and markers indicating where on the user's face the makeup brush has been applied. Alternatively, the representation of the user's face could be displayed next to images and/or videos that indicate to the user how they are supposed to be using the makeup brush. Thus, features disclosed herein can be used to analyze the user's current routine and provide feedback on that routine.

As noted herein, the features shown in FIGS. 9A-9D can also be used when the user 900 is not holding an object in their hand 902. For example, if the user 900 is massaging their face or applying makeup (or another substance) with their fingers, the movement of the user 900's hand 902 adjacent to the various portions of the user 900's face can be tracked to determine whether those portions of the face have been massaged, whether makeup has been applied to those portions of the face, etc. Those portions of the user 900's face can be indicated with markers similar to markers 916A and 916B. In some implementations, the image data is also analyzed to confirm that the user 900's hand 902 (and/or fingers) actually contacted the user 900's face, as discussed herein.

Thus, various different types of modifications can be made to any applications executed using the smart mirror 14 (and/or any other system) based on gestures. Applications can be launched, terminated, switched, etc., based on gestures made by the user. Gestures can be used to navigate within applications and to adjust settings of applications. Gestures can be analyzed to monitor use of objects and track areas of the user adjacent to which the object is moved during use.

In addition to image data, other types of data can also be analyzed to identify gestures and/or identify objects held by the user. Motion data associated with movements of the user can be analyzed to aid in determining gestures. Audio data (for example generated by one or more microphones in a smartphone, a smart speaker, etc.) associated with the user can be analyzed to aid in determining an identity of the user, to aid in determining gestures, to aid in determining the identity of the object, etc. The various features disclosed herein can be used within suitable system. While these features are generally described as being implemented using a smart mirror system, these features could also be used with smart TVs, vehicle entertainment systems, desktop computers, laptop computers, tablet computers, smartphones, etc. In some implementations, the features disclosed herein could be used to monitor movements of multiple people or objects at once. For example, objects and/or workers on a production line could be monitored to optimize processes within the production line. Exercise could also be monitored using the techniques herein. Various different gestures associated with exercise can be defined and identified, in order to monitor the user's technique, compare the user's technique to a target technique, determine which exercise is being performed, count repetitions of the exercise being performed, etc.

One or more elements or aspects or steps, or any portion(s) thereof, from one or more of any of claims 1-102 below can be combined with one or more elements or aspects or steps, or any portion(s) thereof, from one or more of any of the other claims 1-102 or combinations thereof, to form one or more additional implementations and/or claims of the present disclosure.

While the present disclosure has been described with reference to one or more particular embodiments or implementations, those skilled in the art will recognize that many changes may be made thereto without departing from the spirit and scope of the present disclosure. Each of these implementations and obvious variations thereof is contemplated as falling within the spirit and scope of the present disclosure. It is also contemplated that additional implementations according to aspects of the present disclosure may combine any number of features from any of the implementations described herein.

1. A method of modifying execution of one or more applications being executed by one or more processors, the method comprising:
receiving image data reproducible as one or more images of (i) at least a portion of a hand of a user, (ii) at least a portion of an object held in the hand of the user, or (iii) both (i) and (ii);
analyzing the image data, using the one or more processors, to determine (i) one or more gestures performed by the hand of the user, (ii) an identity of the object held in the hand of the user, or (iii) both (i) and (ii); and
based at least in part on the one or more gestures, the identity of the object, or both, modifying the execution of the one or more applications being executed by the one or more processors.

2-6. (canceled)

7. The method of claim 1, wherein execution of the one or more applications includes displaying at least one object on an electronic display device, and wherein modification of the execution of the one or more applications includes causing a modification of the at least one object displayed on the electronic display device to occur, wherein the modification of the least one object displayed on the electronic display device is based at least in part on the one or more gestures performed by the hand of the user.

8. (canceled)

9. The method of claim 7, wherein:
in response to determining that the hand of the user performed a first gesture, the modification of the at least one object displayed on the electronic display device is a first modification; and
in response to determining that the hand of the user performed a second gesture different than the first gesture, the modification of the at least one object displayed on the electronic display device is a second modification.

10. The method of claim 9, wherein the first gesture includes the hand of the user moving from a first position to a second position, and the second gesture includes the hand of the user moving from the second position to the first position, and wherein the first position is a generally closed position, and the second position is a generally open position, and wherein the first gesture includes the hand of the user moving from the generally closed position to the generally open position, and the second gesture includes the hand of the user moving from the generally open position to the generally closed position.

11-16. (canceled)

17. The method of claim 10, wherein in response to determining that the hand of the user performed a third gesture, the modification of the at least one object displayed on the electronic display device is a third modification, wherein the third gesture includes movement of the hand of the user from the first position to an intermediate position between the first position and the second position, or from the second position to the intermediate position.

18-37. (canceled)

38. The method of claim 1, wherein:
in response to determining that the hand of the user performed a first gesture, the modification of the one or more applications is a first modification; and
in response to determining that the hand of the user performed a second gesture different than the first gesture, the modification of the one or more applications is a second modification that is different than the first modification,
wherein the first gesture includes the hand of the user moving from a first position to a second position, and the second gesture includes the hand of the user moving from the second position to the first position.

39. (canceled)

40. The method of claim 38, wherein the first position is a generally closed position, and the second position is a generally open position.

41. The method of claim 40, wherein determining that the hand of the user performed the first gesture or the second gesture includes determining whether the hand of the user is in the generally closed position or the generally open position.

42. The method of claim 41, wherein determining that the hand is in the generally closed position is based at least in part on determining that at least one finger of the hand is in a lowered position.

43. The method of or claim 42, wherein determining that the hand is in the generally open position is based at least in part on determining that at least one finger of the hand is in a raised position.

44. The method of claim 43, wherein determining whether at least one finger of the hand is in the raised position or the lowered position includes:
determining a position of a tip of the at least one finger along an axis;
determining a position of a base of the at least one finger along the axis; and
comparing the position of the tip of the at least one finger to the position of the base of the at least one finger.

45. The method of claim 44, wherein the at least one finger is in the raised position if the base of the at least on finger is closer to an origin of the axis than the tip of the at least one finger.

46. The method of claim 45, wherein the at least one finger is in the lowered position if the tip of the at least one finger is closer to the origin of the axis than the base of the at least one finger.

47. The method of claim 46, wherein determining that the hand is in the generally closed position is based at least in part on determining that a palm of the hand of the user is not visible.

48. The method of claim 47, wherein determining that the hand is in the generally open position is based at least in part on determining that the palm of the hand of the user is visible.

49. The method of claim 48, wherein determining whether the palm of the hand is visible to the one or more image sensors includes:
determining a position of a tip of a thumb of the hand along an axis;
determining a position of a tip of a pinky finger of the hand along the axis;
determining a position of a base of an index finger of the hand along the axis;
determining a position of a base of a pinky finger of the hand along the axis; and
comparing the determined positions.

50. The method of claim 49, wherein comparing the determined positions includes determining whether a first distance between (i) the position of the tip of the thumb and (ii) the position of the tip of the pinky finger is greater than or less than a second distance between (i) the position of the base of the index finger and (ii) the position of the base of the pinky finger.

51-66. (canceled)

67. The method of claim 1, wherein analyzing the image data includes inputting at least a portion of the image data into a machine learning algorithm, the machine learning algorithm being trained to output the one or more gestures performed by the hand of the user, the identity of the object held in the hand of the user, or both, and wherein the portion of the image data inputted into the machine learning algorithm includes a plurality of frames, and wherein the machine learning algorithm is trained to:
analyze the portion of the image data to determine, for each of the plurality of frames, one or more positional characteristics associated with the hand of the user, the object, or both;
determine, based at least in part on the one or more positional characteristics for at least two of the plurality of frames, movement of the hand of the user during a time period that spans at least two of the plurality of frame, movement of the object during the time period, or both; and
based at least in part on the movement of the hand of the user, the movement of the object, or both, identify the one or more gestures performed by the hand of the user during the time period.

68. (canceled)

69. The method of claim 67, wherein the one or more positional characteristics include a location of one or more landmarks on the hand of the user, a location of one or more landmarks on the object, a value of one or more Euler angles associated with the hand of the user, a value of one or more Euler angles associated with the object, a value of one or more quaternions associated with the hand of the user, a value of one or more quaternions associated with the object, or any combination thereof.

70. The method of claim 69, wherein the portion of the image data inputted into the machine learning algorithm includes a plurality of frames, and wherein the machine learning algorithm is trained to:
analyze the portion of the image data to identify, for each respective frame of the plurality of frames, a coordinate of one or more landmarks within the respective frame, each landmark being associated with the hand of the user, the object, or both;
determine a change in the coordinate of each of the one or more landmarks across at least two of the plurality of frame; and
based at least in part on the change in the coordinate of each of the one or more landmarks, identify the one or more gestures performed by the hand of the user between the at least two of the plurality of frames.

71-102. (canceled)
